(19) United States
(12) Patent Application Publication
(10) Pub. No.: US 2008/0209815 A1
(43) Pub. Date: Sep. 4, 2008

(54) LOCKING LATCH HANDLE

(75) Inventor: Hsien-Juey Chiu, Auckland (NZ)

Correspondence Address: DARBY & DARBY P.C., P.O. BOX 770, Church Street Station, New York, NY, 10008-0770, US

(73) Assignee: Maxwell Marine Limited, Albany Auckland (NZ)

(21) Appl. No.: 11/925,276

(22) Filed: Oct. 26, 2007

(30) Foreign Application Priority Data
Oct. 26, 2006 (NZ) 550867

(51) Int. Cl. E05B 13/10; E05B 1/00

(52) U.S. Cl. 49/460; 70/224

(57) ABSTRACT

The invention provides a lockable closure device for a closure that is adapted to selectively cover at least a portion of an opening. The lockable closure device comprises a first handle adapted for provision on one side of the closure, a second handle for provision on the opposite side of the closure, and a connection means by which the handles are pivotally connected relative to the closure such that the first handle may be disposed in a first position in which the second handle cannot be moved, and in a second position in which the second handle can be moved. There is also provided a closure having one or more of said lockable closure devices coupled thereto.

### FIELD OF THE INVENTION

This invention relates to a lockable closure device. More particularly, the invention relates to a locking latch handle. The invention has particular application to a hatch in a marine environment.

### BACKGROUND

Various closure devices presently exist for locking a leaf element, such as a door or a window, in place to cover an opening. Door latch mechanisms typically include a spindle that is coupled to handles on either side of the door, such that when one or other of the handles is rotated, the spindle also rotates. The spindle is also coupled to a slidable latch or bolt that is adapted to engage a recess in the door frame. Turning of the spindle is translated into lateral movement of the latch which causes the latch to leave the recess and allows the door to be opened. Traditionally, door latch mechanisms have been used in combination with a separate locking mechanism to prevent unauthorised or undesired access through the opening. Such arrangements have generally required the use of some form of key.

In certain applications, it is desirable for the opening to be lockable/unlockable from one side only. For example, it is generally desirable for a bathroom door to be lockable only from the inside. Various devices have been devised to achieve this task. At their simplest, these include manually, directly slidable bolts provided on one side of a door. However, more sophisticated arrangements have evolved in which the locking mechanism is incorporated in or integrated in the door latch mechanism to avoid the need for a separate locking mechanism. These locking mechanisms generally include manual switches or buttons. When the door is closed, it may be locked by pressing the switch or button which causes the spindle of the door latch mechanism to become lockably engaged with a locking member coupled to the switch or button. Thus, it is no longer possible to rotate the door handle and so the latch of the door latch mechanism is fixed in the recess, thereby preventing any movement of the door. To unlock the door, the same or a different button or switch must be pressed to disengage the locking member from the spindle.

These arrangements have themselves been developed such that it may be possible to unlock the door, on the side on which it was locked, by simply turning the door handle on that side in a conventional manner, without having to press a switch or button. Clearly, such arrangements are beneficial in that a step is omitted, simplifying operation for users.

Further developments have enabled the locking action of the locking mechanism to be actuated using the door handle. For example, WO-A-04/07877 describes such a door locking mechanism which is adapted to lock by rotation of the door handle in a particular manner. Whilst this may simplify the locking action, the mechanism described is rather complex and requires activation of a trigger to allow the handle to be rotated again (i.e., for the door to be unlocked). This complicates the process of opening a locked door and also the mechanisms used to perform the task.

WO-A-00/71841 and WO-A-02172985 describe door locking mechanisms that use cam arrangements to enable both the locking and unlocking actions to be effected by rotation of one of the door handles in particular manners. Namely, when a door is closed, it may be looked by rotating the handle in a first direction. Subsequent turning of the handle in the opposite direction allows the door to be unlocked and opened. These mechanisms simplify the locking/unlocking actions for a user, but do so at the expense of using complicated arrangements. This complicates and increases the cost of manufacture and also increases the chances of mechanical problems with the mechanism, particularly in view of the complex arrangements of springs that are used.

### SUMMARY OF THE INVENTION

It is an object of the invention to provide a lockable closure device that at least mitigates some or all of the aforementioned problems.

Alternatively, it is an object of the invention to at least provide a useful choice.

According to a first aspect of the invention, there is provided a lockable closure device for a closure that is adapted to selectively cover at least a portion of an opening. The lockable closure device comprises a first handle adapted for provision on one side of the closure, a second handle for provision on the opposite side of the closure, and a connection means by which the handles are pivotally connected relative to the closure such that the first handle may be disposed in a first position in which the second handle cannot be moved, and in a second position in which the second handle can be moved.

Preferably, the device is adapted so that movement of the first handle between the first and second positions is effected by rotation thereof. In a first direction from the first position to the second position, and in a second, opposite direction from the second position to the first position.

Thus, the closure may be locked (to the second handle on the opposite side of the closure) by rotating the first handle to the first position in the first direction and unlocked by rotating the first handle to the second position in the second direction.

Preferably, the device is adapted so that the angle of rotation between the first and second positions is approximately 20°.

Other angles are within the scope of the invention but angles of this approximate value are preferred because they provide a good visual indication that the first handle is in the locked or unlocked position whilst not requiring much movement by a user to make the transition. Thus, a user is not greatly inconvenienced when locking or unlocking the first handle, thereby providing for quick and easy operation for a user.

Preferably, the device is adapted so that the first handle may be disposed in a third position in which the closure may be opened or removed to allow access therethrough.

Preferably, the device is adapted so that the first handle may be disposed in the third position by rotation thereof. More preferably, the first handle may be disposed in the third position by rotation thereof from the first position in the first direction, or by rotation thereof from the second position in the first direction.

Thus, the first handle may be moveable from the first position to the third position in one movement, which corresponds to transitioning the closure device from being locked to unlocked and then capable of being opened.

Preferably, the device is adapted such that rotation of the first handle between the first and second positions is about a first axis and rotation of the first handle between the second and third positions is about a second axis, different from the first axis. Preferably, the first axis is parallel to the second axis. Preferably, any rotation of the second handle is about the second axis.

Preferably, the device comprises latch means adapted to engage a fixed member. Preferably, the fixed member comprises a portion of, or is fixedly coupled to, a wall defining the opening.

Preferably, the latch means is coupled to the first handle. More preferably, the latch means is fixedly coupled, or integral, to the first handle so that rotation of the first handle causes rotation of the latch means.

According to a second aspect, there is provided a closure having one or more lockable closure devices according to the first aspect coupled thereto.

Preferably, the closure is further coupled to hinging means.

Further aspects of the invention, which should be considered in all its novel aspects, will become apparent to those skilled in the art upon reading the following description which provides at least one example of a practical application of the invention.

### BRIEF DESCRIPTION OF THE DRAWINGS

One or more embodiments of the invention will be described below by way of example only and without intending to be limiting with reference to the following drawings, in which:

FIG. 1 shows a perspective view of an embodiment of the invention;

FIGS. 2 and 3 show alternative exploded perspective views of the embodiment of FIG. 1;

FIG. 4 shows a plan view of an embodiment in a first, looked and latched configuration;

FIG. 5 shows a plan view of the embodiment of FIG. 4 in a second, unlocked but latched configuration; and

FIG. 6 shows a plan view of the embodiment of FIGS. 4 and 5 in a third, unlocked and unlatched configuration.

### DETAILED DESCRIPTION OF PREFERRED EMBODIMENTS

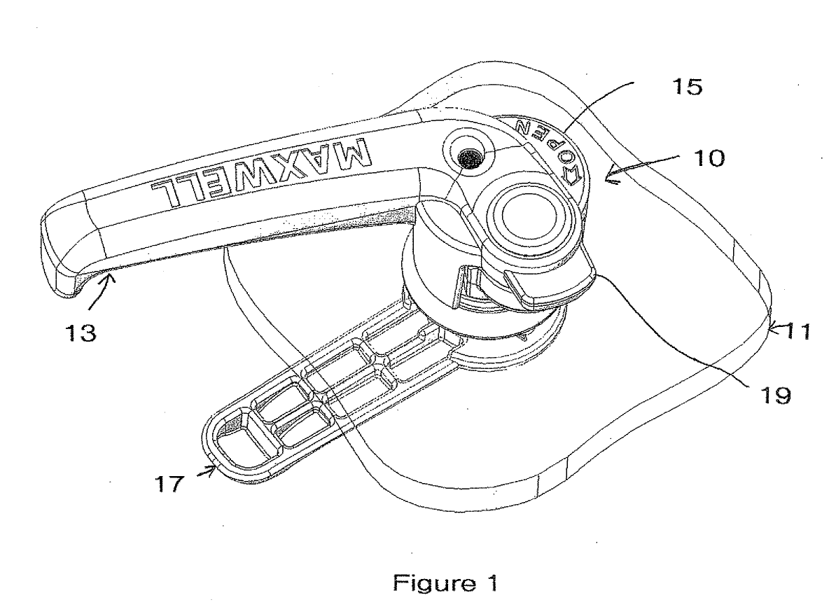

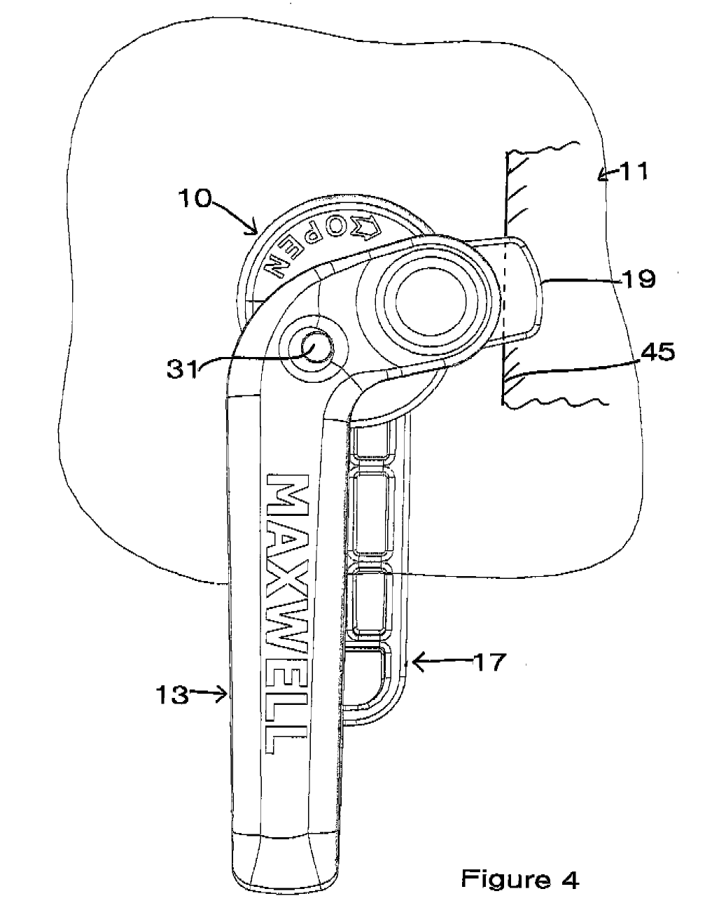

FIG. 1 is an assembled view of lockable closure device 10 coupled to closure 11 according to an embodiment of the invention, Device 10 includes three main parts. Namely, inside handle 13, main body 15 and optional outside handle 17. Inside handle 13 comprises latch 19 that is adapted to engage fixed means (not shown—see FIGS. 4 to 6) that are provided in fixed relation relative to the opening which is to be selectively covered by closure 11. When latch 19 is engaged with the fixed means, movement of closure 11 is inhibited, whereas it is possible when first handle 13 is moved so that latch 19 disengages the fixed means.

According to preferred embodiments, closure 11 is a hatch, such as a hatch suitable for marine environments/applications. More particularly, closure 11 may be for or included on a boat.

Hinge means (not shown) may be provided on a side of closure 11, such that closure 11 may pivot to selectively cover/uncover the opening. Alternatively, a plurality of lockable closure devices 10 may be coupled to a single closure such that the combination of devices 10 inhibits removal of closure 11 from the opening. For example, for a substantially rectangular closure 11, two devices 10 may suffice if they are coupled adjacent to opposite faces thereof. However, in some circumstances, it may be preferable to couple at least one device 10 to each side of closure 11, assuming it is of a substantially polygonal configuration. The invention is not limited to polygonal closures. Moreover, the skilled man would be aware of how to modify the number and spacing of devices 10 around a closure depending on the size and configuration of closure 11, as well as on the desired integrity and security of the seal between closure 11 and the wall of the opening, and it is therefore intended that all such modifications be included within the scope of the claims.

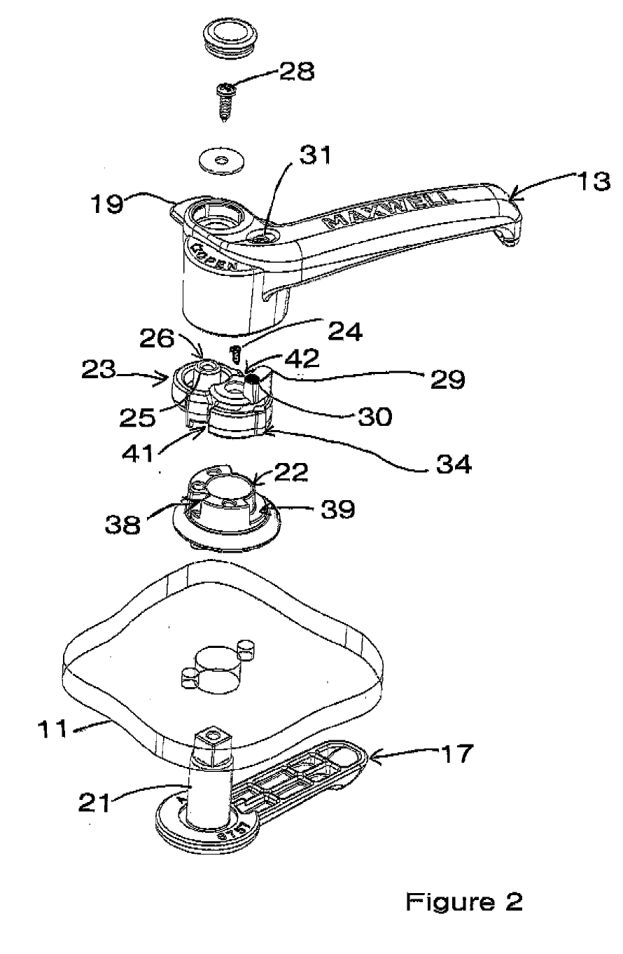

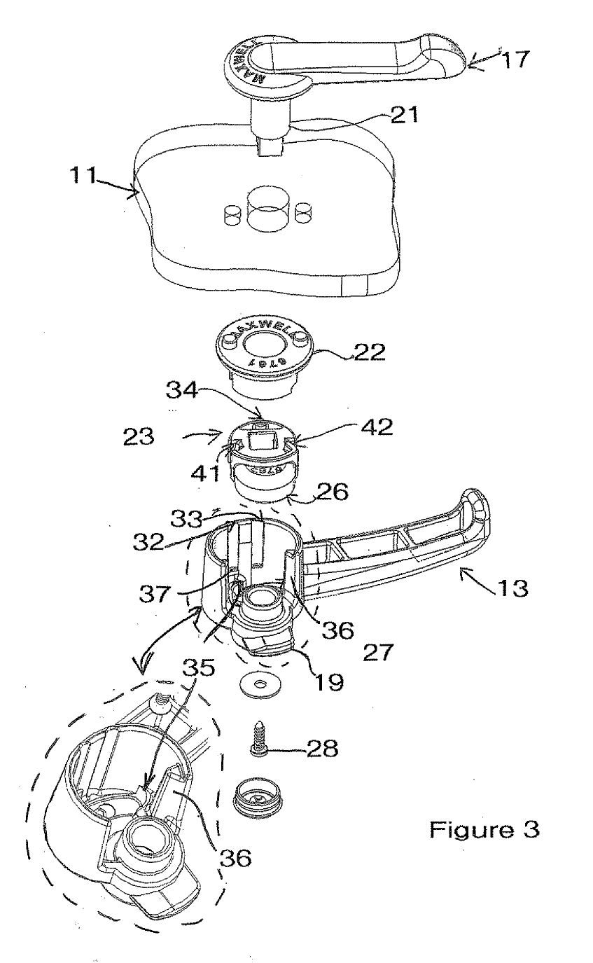

FIGS. 2 and 3 are exploded views of device 10 of FIG. 1 from different perspectives. These Figures serve to show the internal workings of main body 15. Outside handle 17 comprises, or is fixedly coupled to, spindle 21 that fits in an aperture provided in closure 11 so that spindle 21 (and hence outside handle 17) may rotate in a direction substantially perpendicular to spindle 21 and/or substantially perpendicular to at least the proximate portion of closure 11. An end portion of spindle 21, distal from outside handle 17, is in the form of a square male section.

Locking bush 22 sits on a portion of spindle 21 abutting the inside wall of closure 11. Means are provided for maintaining locking bush 22 in a fixed position relative to closure 11 so that it does not rotate as other components of device 10 rotate. In the embodiment shown, these means comprise one or more holes provided in closure 11, each of which is adapted to mate with a corresponding pin provided on locking bush 22 such that locking bush 22 is unable to rotate about the same axis as spindle 21. Alternatively, one or more pins could be provided on closure 11, each of which mates with a hole provided in locking bush 22. The skilled man would also be aware of other means, including adhesives, that may be used to lock locking bush 22 against rotation (relative to closure 11) as other components of device 10 rotate and it is intended that all such means be included within the scope of the invention.

Crank 23 sits on locking bush 22 with the square male section of spindle 21 mating with a female square recess (see FIG. 3) provided in crank 23. Thus, crank 23 is directly rotationally coupled to outside handle 17 such that rotation of outside handle 17 causes substantially the same rotation of crank 23 and vice versa. Crank 23 is coupled to outside handle 17 using, for example, screw 24 that engages a hole (see FIG. 2) In the and of the square male section of spindle 21. To allow for different thicknesses of closure 11, the length of engagement of the square male section of spindle 21 and the female square recess in crank 23 may, for example, be varied accordingly. Alternatively, the thickness of locking bush 22 and/or the thickness of crank 23 and/or the length of other portions of spindle 21 may be varied.

Inside handle 13 fits over crank 23 and locates on boss 25 (see FIG. 2) of offset feature 26 of crank 23. More particularly, boss 25 of crank 23 (see FIG. 2) nests in circumferential boss 27 provided inside of inside handle 13 (see FIG. 3). Inside handle 13 is preferably coupled to crank 23, such as by screw 28 which passes through circumferential boss 27 and engages an aperture provided in boss 25 (see FIG. 2).

Crank 23 further includes raised boss 29 which is provided with visual indicator means 30 (see FIG. 2). Visual indicator means 30 preferably comprises a coloured spot that cooperates with window 31 to indicate to a user whether device 10 is locked (i.e., whether outside handle 17 may be rotated).

The inside of inside handle 13 comprises a number of functional elements (see FIG. 3). Detents 32 and 33 are adapted to cooperate with ribbed protrusion 34 on crank 23 so as to provide a user with a positive feel as to when device 10 transitions from being looked to being unlocked, and vice versa. More particularly, when protrusion 34 is engaged in detent 32, device 10 is locked, with rotation of outside handle inhibited. On the other hand, when protrusion 34 is engaged in detent 33, visual indicator means 30 is visible through window 31 and device 10 is unlocked such that closure 11 may be opened using outside handle 17 (as well as inside handle 13). Delimiting means 35 are provided to limit the angle of rotation of crank 23 relative to inside handle 13 in either direction (although from the perspective of FIG. 3, it is only possible to see one half of delimiting means 35). Preferably, the angle of rotation is limited to 20°, which corresponds to the preferred extent of movement required for inside handle 13 to transition device 10 from being locked to being unlocked and vice versa.

The inside of inside handle 13 also includes first rib 36 and similar, second rib 37 (see FIG. 3). Ribs 36 and 37 cooperate with first slot 38 and second slot 39 (see FIG. 2) of looking bush 22, and first groove 41 and second groove 42 of crank 23 to enable device 10 to perform the locking/unlocking functions, as well as enable latch 19 to disengage from the fixed means.

Operation of the invention will now be described with reference to FIGS. 4 to 6. FIG. 4 shows device 10 according to an embodiment of the present invention in a locked, latched configuration. In FIG. 4, handles 13 and 17 are aligned and closure 11 is in a closed position with latch 19 engaged against a fixed means, such as a slot in a frame 45 around the opening. When inside handle 13 is oriented as shown in FIG. 4, outside handle 17 is looked. Therefore, in this position, a user attempting to rotate outside handle 17 to open closure 11 would not be able to do so and visual indicator means 30, through window 31, provides a visual indication that the device is locked. Referring to FIGS. 2 and 3, in the locked configuration of FIG. 4, rib 37 is engaged in first slot 38 and first groove 41, thereby looking outside handle 17 from being rotated.

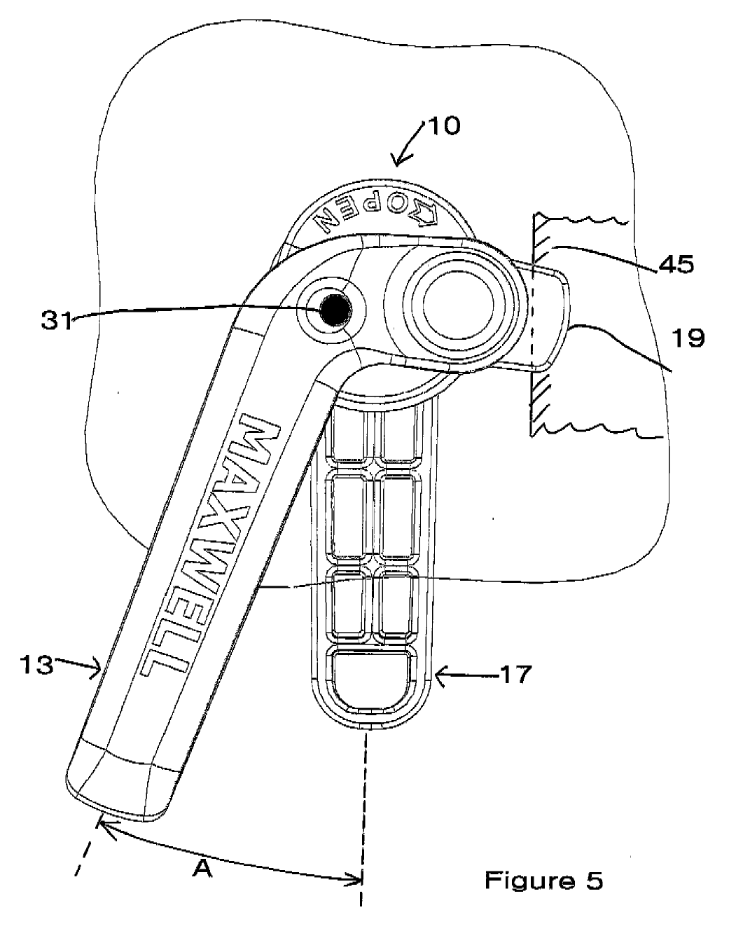

When inside handle 13 is moved from the position shown in FIG. 4 through arc A (preferably 20°) to the position shown in FIG. 5, outside handle 17 does not move, but device 10 transitions from a locked, latched state to an unlocked, latched state and visual indicator means 30 now shows that device 10 is unlocked. More particularly, during the rotation through arc A, raised boss 29 (FIG. 2) moves from abutting one extent of delimiting means 35, to the other, with circumferential boss 27 of inside handle 13 rotating about boss 25 of crank 23. At the same time, rib 37 disengages from first slot 38 and first groove 41 and rib 36 engages second slot 39 and groove 42.

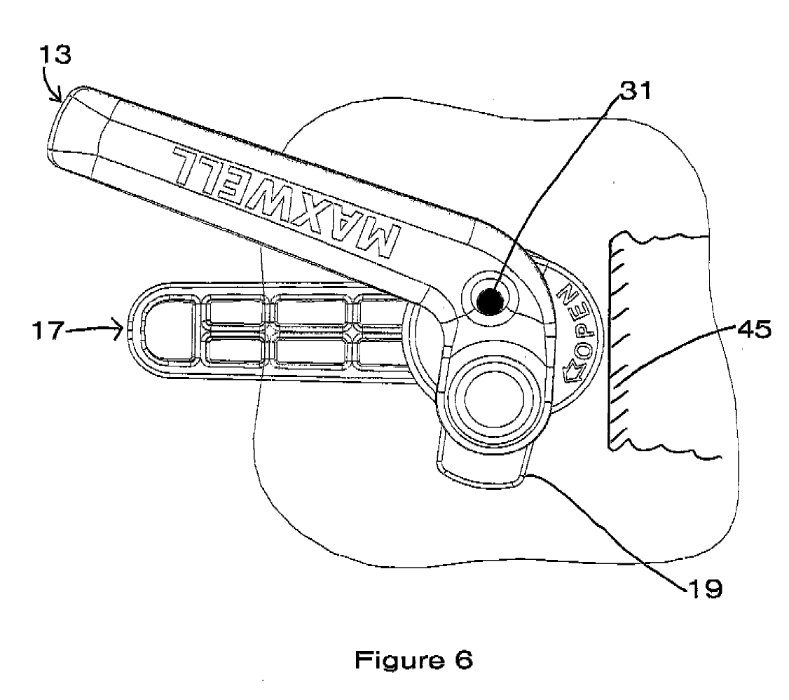

From this position, continued rotation of inside handle 13 in a clockwise direction converts to rotational movement about spindle 21 (as opposed to the previous rotation about boss 25). Moreover, the presence of rib 36 in groove 42 and raised boss 29 in delimiting means 35, results in the two handles being directly rotationally coupled about spindle 21 so that latch 19 may be moved to disengage from the fixed means to arrive at the configuration shown in FIG. 6 by turning either handle 13, 17. The extent of this rotational movement is set by the angular extent of second slot 39 in locking bush 22 since rib 36 moves in this slot during the rotation and hence its movement is limited by the end walls of slot 39. As indicated in FIG. 6, visual indicator means 30 continues to show that device 10 is unlocked. In the position shown in FIG. 6, latch 19 is disengaged from frame 41, allowing closure 11 to be opened.

Conversely, starting with closure 11 in an open position with handles 13 and 17 in the configuration shown in FIG. 6, transitioning to the configuration shown in FIG. 5 is effected by moving closure 11 into a closed position and rotating either handle 13 and 17 in an anticlockwise direction (as viewed from the perspective of FIGS. 4 to 6). If outside handle 17 is rotated to its maximum extent anticlockwise, device 10 transitions to the configuration shown in FIG. 5, with closure 10 in an unlocked but latched configuration. Thus, it is not possible to lock the device 10 from the outside. On the other hand, if inside handle 13 is rotated to its maximum extent anticlockwise, device 10 transitions to the locked and latched configuration, as shown in FIG. 4. Using inside handle 13, arriving at the position shown in FIG. 5 and also determining when device 10 is locked, is facilitated by the positive feel provided by detents 32 ad 33 in combination with protrusion 34. Visual indicator means 30 also provides an indication through window 31 when device 10 switches from being unlocked to being locked.

Therefore, according to the present invention, the user need only turn the inside handle in a seemingly conventional manner to lock or unlock device 10. A locking button or other device is not required to be pushed or activated by the user.

As stated above, outside handle 17 is optional. A dome cap, for example, may be provided in place of handle 17.

Throughout the detailed description, references have been made to “inside” and “outside” relative to closure 11. It would be clear to one of skill in the art that the locking handle (i.e., inside handle 13) could be provided on either side of closure 11. Thus, a handle similar to inside handle 13 could be provided outside of a closure, with a corresponding handle similar to outside handle 17 being provided inside of the closure. It is intended that such modifications be included within the scope of the invention.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Wherein the foregoing description reference has been made to specific components or integers of the invention having known equivalents then such equivalents are herein incorporated as if individually set forth.

It should be noted that various changes and modifications to the presently preferred embodiments described herein will be apparent to those skilled in the art. Such changes and modifications may be made without departing from the spirit and scope of the present invention and without diminishing its attendant advantages. It is therefore, intended that such changes and modifications be included within the present invention.

1. A lockable closure device for a closure that is adapted to selectively cover at least a portion of an opening, the lockable closure device comprising:
a first handle adapted for provision on one side of the closure;
a second handle for provision on the opposite side of the closure; and
a connection means by which the handles are, pivotally connected relative to the closure such that the first handle may be disposed in a first position in which the second handle cannot be moved, and in a second position in which the second handle can be moved.

2. The lockable closure device of claim 1, wherein the connection means is configured such that the first handle may be disposed in a third position in which the closure may be opened or removed to allow access therethrough.

3. The lockable closure device of claim 1, wherein the connection means is configured such that the first handle is rotatable from the first position to the second position in a first direction.

4. The lockable closure device of claim 3, wherein the connection means is further configured such that the first handle is rotatable from the second position to the first position in a second direction, the second direction being opposite to the first direction.

5. The lockable closure device of claim 3, wherein the angle of rotation between the first and second positions is approximately 20°.

6. The lockable closure device of claim 3, wherein the connection means is configured such that rotation of the first handle between the first and second positions is about a first axis.

7. The lockable closure device of claim 2, wherein the connection means is configured such that the first handle may be disposed in the third position by rotation thereof.

8. The lockable closure device of claim 6, wherein the connection means is configured such that the first handle may be disposed in a third position by rotation thereof in the first direction.

9. The lockable closure device of claim 8, wherein the connection means is configured such that, rotation of the first handle between the second and third positions is about a second axis.

10. The lockable closure device of claim 9, wherein the first axis is parallel to the second axis.

11. The lockable closure device of claim 9, wherein the connection means is configured such that any rotation of the second handle is about the second axis.

12. The lockable closure device of claim 1, comprising latch means adapted to engage a fixed member.

13. The lockable closure device of claim 12, wherein the latch means is coupled to the first handle.

14. The lockable closure device of claim 13, wherein the latch means is fixedly coupled or integral to the first handle.

15. A closure comprising one or more lockable closure devices, wherein at least one of the lockable closure devices further comprises:
a first handle adapted for provision on one side of the closure;
a second handle for provision on the opposite side of the closure; and
a connection means by which the handles are, pivotally connected relative to the closure such that the first handle may be disposed in a first position in which the second handle cannot be moved, and in a second position in which the second handle can be moved.

16. The closure of claim 15, comprising hinging means coupled thereto.

17. The lockable closure device of claim 6, wherein the connection means is configured such that the first handle may be disposed in a third position in which the closure may be opened or removed to allow access therethrough.
